(19) United States
(12) Patent Application Publication
(10) Pub. No.: US 2006/0061524 A1
(43) Pub. Date: Mar. 23, 2006

(54) Light emitting display and method of fabricating the same

(76) Inventors: Mi Sook Suh, Kyunggi-do (KR); Byung Hee Kim, Kyunggi-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/214,450

(22) Filed: Aug. 29, 2005

(30) Foreign Application Priority Data
Aug. 30, 2004 (KR) 10-2004-0068406

(51) Int. Cl. G09G 3/30

(52) U.S. Cl. 345/76

(57) ABSTRACT

A light emitting display and method of fabricating the same are disclosed, wherein the light emitting display is capable of measuring the properties of a light emitting diode without the influence of a transistor. Embodiments of the light emitting display comprise a first display portion formed on a substrate and having a first pixel configured to emit light based on a current from an active driving pixel circuit having at least one transistor; and a second display portion having a second pixel configured to emit light based on a current supplied by a passive driving type on the substrate. Thereby, the luminous properties of a light emitting diode in the light emitting display can be evaluated without the influence of the transistor using a test pixel portion formed in a dummy region of the substrate.

### CROSS-REFERENCE TO RELATED APPLICATIONS

This application claims priority to and the benefit of Korean Patent Application No. 10-2004-0068406, filed Aug. 30, 2004, the disclosure of which is hereby incorporated by reference in its entirety.

### BACKGROUND

1. Field of the Invention

The present invention relates to a light emitting display and, more particularly, to a light emitting display and method of fabricating the same capable of measuring properties of a light emitting diode without the influence of a transistor.

2. Discussion of Related Technology

Recently, various flat panel displays have been developed with reduced weight and volume to overcome the disadvantages of a cathode ray tube (CRT) displays. Types of flat panel displays include a liquid crystal display (LCD), a field emission display (FED), a plasma display panel (PDP), and a light emitting diode (LED) display, for example.

A light emitting display can emit light independently from a fluorescent material using recombination of electrons and holes, and is generally classified into two types based on its material and structure: an inorganic light emitting display including an inorganic emission layer, and an organic light emitting display including an organic emission layer. The light emitting display advantageously has a rapid response speed, like CRT displays, in comparison with a passive light emitting diode display that requires an individual light source, such as LCD.

An organic light emitting display includes an emission layer (EML) formed between an anode electrode and a cathode electrode, an electron transport layer (ETL), and a hole transport layer (HTL). The organic light emitting display may further include an electron injection layer (EIL) and a hole injection layer (HIL).

When a voltage is applied between the anode electrode and the cathode electrode, electrons emitted from the cathode electrode are transported to the emission layer through the electron injection layer and the electron transport layer, and holes emitted from the anode electrode are transported to the emission layer through the hole injection layer and the hole transport layer. As a result, the electrons supplied from the electron transport layer and the holes supplied from the hole transport layer are recombined to emit light.

A light emitting display can be classified based on driving type as either a passive matrix driving type (hereinafter referred to as “PM”) or an active matrix driving type (hereinafter referred to as “AM”).

The PM light emitting display is disposed in a simple matrix shape such that a first electrode and a second electrode intersect each other, and includes a pixel formed at an intersection of the first electrode and the second electrode. The PM light emitting display displays images by selecting pixels for emission based on data signals supplied by data lines when scan lines are sequentially selected. The PM light emitting display has an advantageously simple and therefore low cost manufacturing process. However, the PM light emitting display also has the disadvantages of increased power consumption and difficulty in implementation of high resolution and large screen displays.

The AM light emitting display includes pixels formed in pixel regions defined by scan lines and data lines, and pixel circuits for emitting light from each pixel using at least one transistor. Images are displayed on the AM light emitting display by independent emission of light from each pixel, wherein each pixel emits light by driving the individual pixel circuits. The AM light emitting display is advantageously capable of realizing high resolution and large screen displays, improving image quality, reducing power consumption, and increasing display life time in comparison with the PM light emitting display.

During manufacture of the AM light emitting display, a light emitting diode electrically connected to a transistor of each pixel circuit is formed after fabrication of a transistor array substrate, wherein fabrication of the transistor array substrate comprises formation of a scan line, a data line, a power line, and the pixel circuit.

This manufacturing process of the AM light emitting display may cause problems such as dark spots, bright spots, stains, and low brightness when images are displayed. Problems due to the light emitting diode can be detected after forming the light emitting diode on the transistor array substrate. Therefore, during the manufacturing process of the AM light emitting display, it may be advantageous to evaluate the properties of the transistor array substrate and the properties of the light emitting diode. However, in the typical AM light emitting display, the properties of the transistor array substrate can be indirectly measured, but the properties of only the light emitting diode independent of the influence of the transistor cannot be measured.

### SUMMARY OF CERTAIN INVENTIVE EMBODIMENTS

Embodiments of the invention, therefore, solve the aforementioned problems associated with conventional displays by providing a light emitting display and method of fabricating the same capable of measuring the properties of a light emitting diode independent of the influence of a transistor.

In one embodiment of the invention, a light emitting display comprises a first display portion formed on a substrate and having a first pixel, wherein the first pixel is configured to emit light based on a current from an active driving pixel circuit having at least one transistor, and a second display portion having a second pixel configured to emit light based on a current supplied by a passive driving pixel on the substrate.

The first pixel may include a light emitting diode configured to emit light based on a current supplied from a first power line by the pixel circuit, wherein the pixel circuit is electrically connected to a scan line, a data line, and the first power line. In addition, the second pixel may include a dummy light emitting diode electrically connected to a dummy power line and a second power line. Further, the second display portion may be used for test.

In another embodiment of the invention, a light emitting display comprises a display portion formed on a substrate and comprising a pixel, wherein the pixel is configured to emit light based on a current supplied from a first power line by a pixel circuit having at least one transistor. The light emitting display further comprises a test portion formed in a dummy region of the display portion and comprising a dummy pixel emitting light based on a current supplied from a dummy power line.

The pixel may include a light emitting diode configured to emit light based on a current supplied from the first power line by the pixel circuit, wherein the pixel circuit is electrically connected to a scan line, a data line, and the first power line. In addition, the dummy pixel may include a dummy light emitting diode electrically connected to the dummy power line and a second power line.

In yet another embodiment of the invention, a light emitting display comprises a display portion formed in an emission region of a substrate and configured to display images, and a test portion formed in a dummy region of the emission region together with the display portion.

The display portion may include a pixel circuit electrically connected to a scan line, a data line, and a first power line, each formed in the substrate, and a pixel comprising a light emitting diode configured to emit light in response to receipt of a current corresponding to data signals supplied to the data line, by the pixel circuit, from the first power line. In addition, the test portion may include a dummy pixel comprising a dummy light emitting diode electrically connected to a dummy power line and a second power line, each formed on the substrate.

In still another embodiment of the invention, a method of fabricating a light emitting display comprises forming a pixel circuit defined by a plurality of scan lines, a plurality of data lines, and a power line in an emission region of a substrate, wherein the pixel circuit comprises at least one transistor configured to output a current from the power line corresponding to data signals of the data line. The method further comprises forming a dummy power line in an anode electrode connected to the pixel circuit and, a dummy region of the emission region, forming a light emitting diode for connection to the pixel circuit and forming a dummy light emitting diode for connection to the dummy power line, and forming a cathode electrode on the light emitting diode and the dummy light emitting diode.

The method may further comprise forming an insulating layer configured to separate the light emitting diode and the dummy light emitting diode from each other. In addition, forming the pixel circuit may include forming a buffer layer on the substrate, forming at least one transistor and capacitor on the buffer layer, and forming a passivation layer covering the transistor.

### BRIEF DESCRIPTION OF THE DRAWINGS

The above and other features of the present invention will be described in reference to certain exemplary embodiments thereof with reference to the attached drawings in which:

FIG. 1 is an illustration of one embodiment of a light emitting display comprising display pixels and test pixels;

FIG. 2 is a circuit diagram of a display pixel shown in FIG. 1;

FIG. 3 is a circuit diagram of one embodiment of the test pixel shown in FIG. 1;

FIG. 4 is an enlarged view of the portion A shown in FIG. 1;

FIGS. 5A to 5C are cross-sectional views taken along line I-I′ shown in of FIG. 4, sequentially illustrating one embodiment of a method of fabricating a light emitting display;

FIGS. 6A to 6C are cross-sectional views taken along line I-I′ shown in of FIG. 4, sequentially illustrating another embodiment of a method of fabricating a light emitting display;

FIG. 7 is an illustration of a second embodiment of a light emitting display;

FIG. 8 is an enlarged view of the area B shown in FIG. 7;

FIGS. 9A to 9C are cross-sectional views taken along line II-II′ shown in of FIG. 8, sequentially illustrating one embodiment of a method of fabricating a light emitting display;

FIGS 10A to 10C are alternative cross-sectional views taken along line II-II′ of FIG. 8, sequentially illustrating a method of fabricating a light emitting display;

FIG. 11 is an enlarged view illustrating an alternative layout of the portion B shown in FIG. 8;

FIG. 12 is a cross-sectional view taken along line III-III′ shown in FIG. 11;

FIG. 13 is an enlarged view illustrating an alternative layout of the portion A shown in FIG. 1; and

FIG. 14 is a cross-sectional view taken along line IV-IV′ shown in FIG. 13.

### DETAILED DESCRIPTION OF CERTAIN INVENTIVE EMBODIMENTS

Embodiments of the invention will now be described more fully hereinafter with reference to the accompanying drawings.

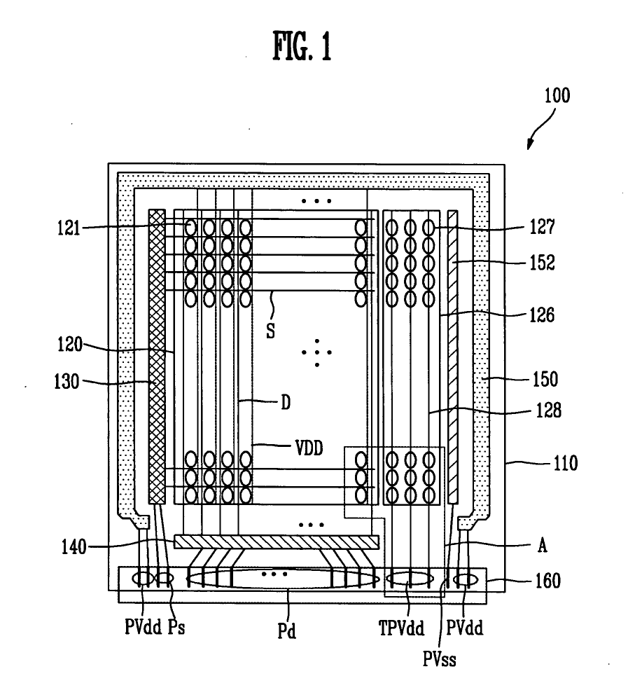

FIG. 1 is an illustration of one embodiment of a light emitting display 100 in accordance with an embodiment of the present invention. The light emitting display 100 comprises a display portion 120 and a test pixel portion 126 (or a dummy pixel portion) located on a substrate 110. In addition, the light emitting display 100 may include a scan driver 130, a data driver 140, a first power line 150, a second power line 152, and a pad portion 160.

The display portion 120 comprises a plurality of display pixels 121 (or pixels) defined by a plurality of data lines D, a plurality of scan lines S, and a plurality of pixel power lines VDD. Each pixel 121 comprises a light emitting diode and a pixel circuit including at least one transistor. In one embodiment, the display portion 120 is formed on a display pixel region (or an emission region) of the substrate 110.

The test pixel portion 126 is formed in a dummy region (or a dummy region of the display portion 120) of the substrate 110 adjacent to the display portion 120. The test pixel portion 126 comprises a test power line 128 (or a dummy power line) electrically connected to a test power supply pad TPVdd of the pad portion 160, and a test light emitting diode (LED) (or a plurality of dummy LEDs) formed between cathode electrodes electrically connected to the test power line 128 and the second power line 152. In one embodiment, the test pixel portion 126 is formed in a test pixel region independent from the display pixel region on the substrate 110.

The scan driver 130 is disposed adjacent to one side of the display portion 120 for electrical connection to first pads Ps of the pad portion 160. The scan driver 130 is configured to generate scan signals based on a scan control signal from the first pads Ps and sequentially supply the scan signals to scan lines S of the display portion 120.

The data driver 140 is electrically connected to data lines D and second pads Pd of the pad portion 160. The data driver 140 may be mounted on the substrate 110 using a chip on glass method, a wire bonding method, a flip chip method and a beam lead method, or directly formed on the substrate 110, for example. The data driver 140 is configured to receive data control signals and data signals from the second pads Pd, and supply the data signals to the data lines D based on the data control signals. The data lines D are electrically connected to the second pads Pd.

Thus, the data driver 140 is electrically connected to the data lines D of the display portion 120 through the pad portion 160 of the substrate 110 to supply the data signals. In one embodiment, the data driver 140 is mounted on a flexible printed circuit (not shown) connected to the substrate 110. Alternatively, the data driver 140 may be incorporated into a chip on board (COB) which is mounted on a printed circuit board, chip on film (COF) directly mounted on a film, or a conventional film type connecting device employed to a tape carrier package, for example.

The first power line 150 is formed along a periphery of the substrate 110 adjacent both a left and a right side and an upper side of the display portion 120, except for the area of the display where the pad portion 160 is formed. Both ends of the first power line 150 are electrically connected to third pads Pvdd of the pad portion 160. The first power line 150 is configured to supply a first power source supplied from a voltage generating portion (not shown) to a pixel power line VDD of each display pixel 121 through the third pads Pvdd.

The second power line 152 is formed adjacent to one side of the display portion 120, and electrically connected to the cathode electrode formed in a front surface of the display portion 120. The second power line 152 is configured to commonly supply a second power source transmitted from fourth pads Pvss of the pad portion 160 to each display pixel 121.

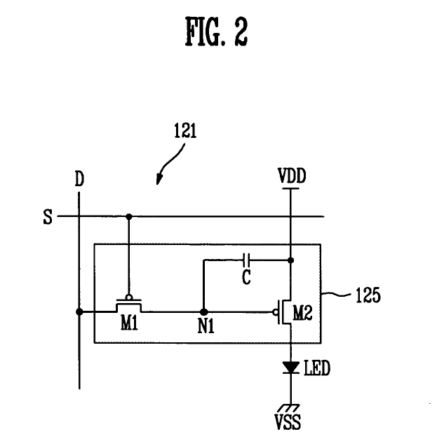

FIG. 2 is a circuit diagram of the display pixel 121 of the display 100 of FIG. 1. Referring to FIGS. 1 and 2, each display pixel 121 comprises a light emitting diode (LED) and a pixel circuit 125. The display pixel 121 is selected by the scan signals applied to the scan line S, and emits light corresponding to the data signals supplied to the data line D.

The anode electrode of the display LED is connected to the pixel circuit 125, and the cathode electrode is electrically connected to the second power line 152. Thus, one embodiment of the light emitting display may be an organic light emitting display. The organic light emitting display comprises an emission layer (EML) made of organic material, an electron transport layer (ETL), and a hole transport layer (HTL) formed between the anode electrode and the cathode electrode. In addition, the organic light emitting display may further include an electron injection layer (EIL) and a hole injection layer (HIL). In operation of the organic light emitting display, when a voltage is applied between the anode electrode and the cathode electrode, electrons emitted from the cathode electrode are transported toward the emission layer through the electron injection layer and the electron transport layer, and holes generated from the anode electrodes are transported toward the emission layer through the hole injection layer and the hole transport layer. As a result, the electrons and holes supplied from the electron transport layer and the hole transport layer collide with each other for recombination to emit light.

Referring again to FIG. 2, the pixel circuit 125 further comprises first and second transistors M1 and M2, and a capacitor C. A gate electrode of the first transistor M1 is connected to the scan line S, a source electrode is connected to the data line D, and a drain electrode is connected to a first node N1. The first transistor M1 is configured to supply the data signals from the data line D to the first node N1 in response to the scan signals supplied to the scan line S.

A gate electrode of the second transistor M2 is connected to the first node N1, wherein the drain electrode of the first transistor M1 and the capacitor C are commonly connected the first node N1. A source electrode of the second transistor M2 is connected to a pixel power line VDD, and a drain electrode is connected to an anode electrode of the display LED. The second transistor M2 is configured to adjust a current supplied to the display LED from the pixel power line VDD, so as to emit light from the display LED based on a voltage supplied to the gate electrode of the second transistor M2.

The capacitor C is configured to store a voltage corresponding to the data signal supplied to the first node N1 via the first transistor M1, wherein selection signals are supplied to the scan line S, which is coupled to the gate electrode of the first transistor M1. When the first transistor M1 is open, the capacitor C maintains the second transistor M2 in an “on” state during one frame.

In the light emitting display 100, the pixel circuit 125 of each display pixel 121 is not limited by the two transistors M1 and M2 and the single capacitor C, but generally includes at least two transistors and at least one capacitor.

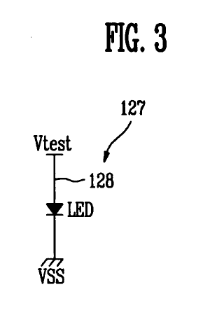

FIG. 3 is a circuit diagram of a test pixel of the light emitting display of FIG. 1. Referring together to FIGS. 1 and 3, the test pixel 127 comprises a plurality of test LEDs formed between a plurality of test power lines 128 and the second power source VSS.

The anode electrode of each test LED is electrically connected to the test power line 128, and the cathode electrode is electrically connected to the second power line VSS. Each test LED emits light by a current responsive to a voltage difference between a test power source Vtest, supplied through the test power line 128 from a test power supply pad TPVdd, and the second power source supplied to the second power line 152.

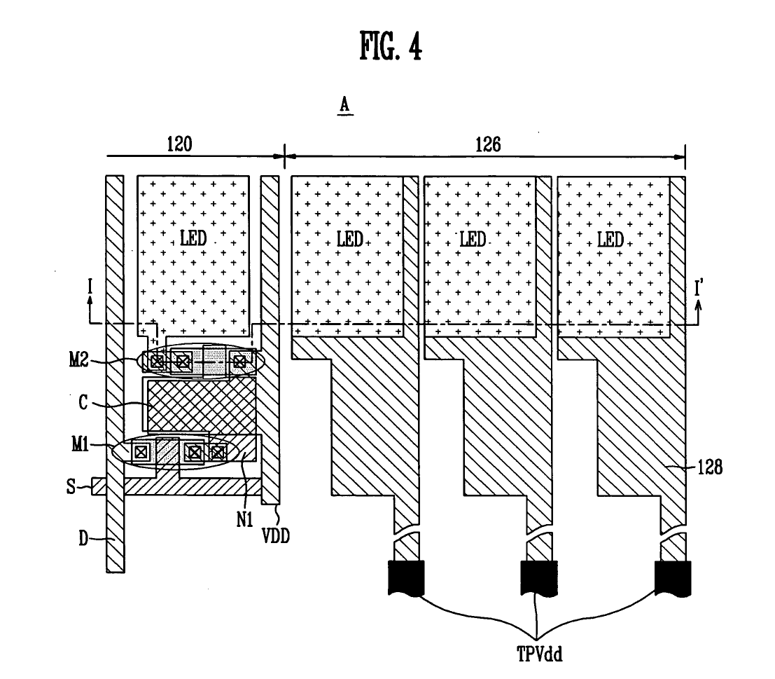

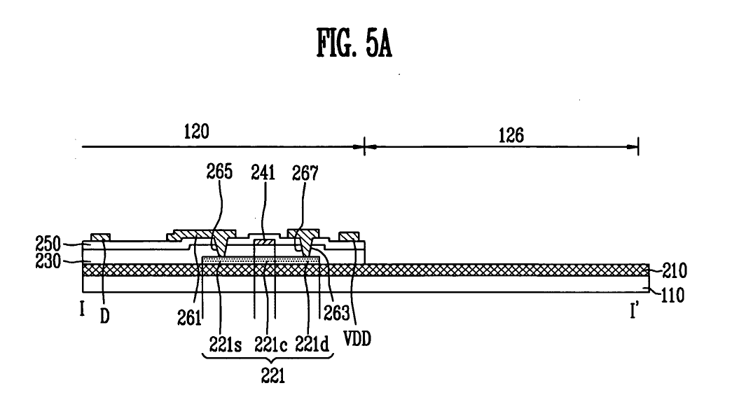

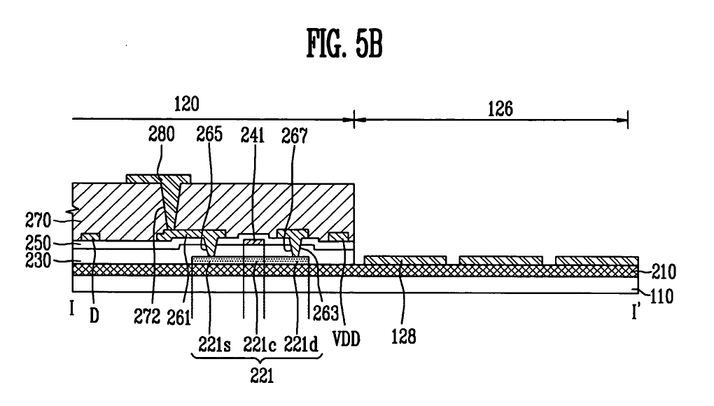

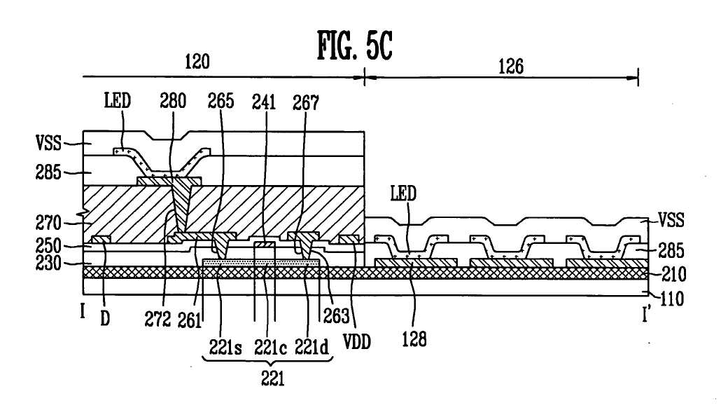

FIG. 4 is an enlarged view of the area A shown in FIG. 1, and FIGS. 5A to 5C are cross-sectional views taken along the line I-I′ of FIG. 4, sequentially illustrating one embodiment of a method of fabricating a light emitting display.

Hereinafter, methods of fabricating a display portion 120 and a test pixel portion 126 will be described in conjunction with FIGS. 4, and 5A to 5C. The method of fabricating the display portion 120 will be described in an exemplary fashion using only a second transistor M2 and a display LED of a pixel circuit 125 of each display pixel 121. In one embodiment, a method of fabricating the first transistor M1 is the same as the method of fabricating the second transistor M2.

First, as shown in FIG. 5A, a buffer layer 210 is formed on substantially an entire surface of a substrate 110. Following formation of the buffer layer 210, a semiconductor layer 221 for a predetermined patterned transistor is formed on the buffer layer 210 in a display pixel region corresponding to the display portion 120. In one embodiment, the semiconductor layer 221 is formed of polycrystalline silicon and obtained by heat treatment of amorphous silicon. In certain embodiments, the amorphous silicon is crystallized to the polysilicon using a laser crystallization process comprising scanning a line beam using an excimer laser in a row direction.

After formation of the semiconductor layer 221, a gate insulating layer 230 is formed on the buffer layer 210 and the semiconductor layer 221. The gate insulating layer 230 may comprise an insulating material such as SiO₂. Following formation of the gate insulating layer 230, a gate electrode 241 is formed on the gate insulating layer 230 to overlap the semiconductor layer 221. The gate electrode 241 may comprise a conductive material such as Al, MoW, Al/Cu. In one embodiment, the scan line S is formed of the same material and at the same time as the gate electrode 241.

After formation of the gate electrode 241, ions are doped into a source region 221s and a drain region 221d of the semiconductor layer 221 of the substrate 110. Thereby, a channel 221c is formed between the source region 221s and the drain region 221d.

Also following formation of the gate electrode 241, an interlayer insulating layer 250 is formed on the gate electrode 241. Subsequently, contact holes 265 and 267 are formed in the interlayer insulating layer 250 and the gate insulating layer 230 to expose the semiconductor layer 221.

After formation of the contact holes 265 and 267, a source electrode 261 and a drain electrode 263, comprising metal materials, are formed on the interlayer insulating layer 250 in predetermined patterns. The source electrode 261 and the drain electrode 263 are electrically connected to the source region 221s and the drain region 221d through the contact holes 265 and 267, respectively.

A data line D and a pixel power line VDD are formed together with the source electrode 261 and the drain electrode 263. Simultaneously, test power lines are formed on the buffer layer 210 in the test pixel region on the substrate, wherein the test power lines are spaced apart from each other by a predetermined interval. In one embodiment, the test power line 128 is formed using the same mask as that used for formation of the pixel power line VDD.

Referring now to FIG. 5B, a passivation layer 270 is formed on the substrate 110 corresponding to the display pixel region. Next, a contact hole 272 is formed in the passivation layer 270 to expose the drain electrode 261. After formation of the contact hole 272, a lower electrode layer 280 (implemented as the anode electrode of the display LED) is formed on the passivation layer 270. Thereby, the lower electrode layer 280 is electrically connected to the drain region 221d through the contact hole 272.

Referring now to FIG. 5C, a pixel defining layer 285 is formed on the lower electrode layer 280 and the passivation layer 270 of the display pixel region, and a pixel defining layer is simultaneously formed on the test power line 128 of the test pixel region (see FIG. 4). An opening dividing the pixel region is formed in the pixel defining layer 285, the display LED is formed in the opening, and simultaneously, the test LED is formed on the test power line 128 formed in the test pixel portion. In one embodiment, the test LED is simultaneously formed using the same mask as that used for forming the display LED.

Furthermore, an upper electrode layer VSS, implemented as the cathode electrode of a light emitting diode 290 and the test LED, is formed on the light emitting diode 290 and the test LED. The upper electrode layer VSS is electrically connected to the second power line 152.

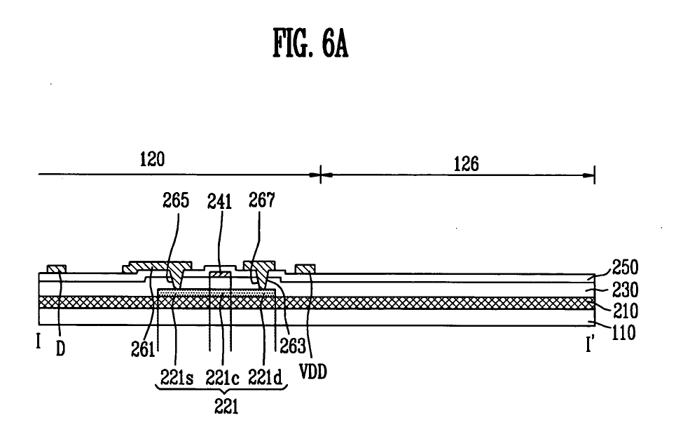

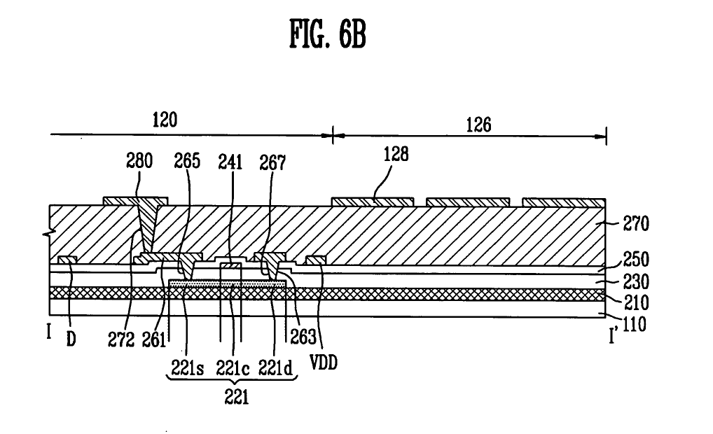

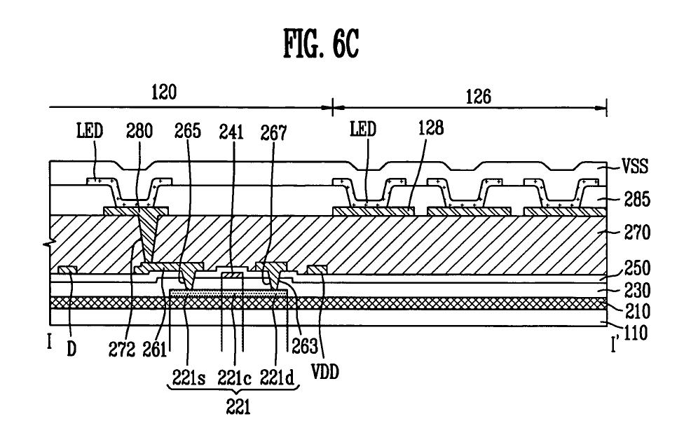

FIGS. 6A to 6C are cross-sectional views taken along line I-I′ of FIG. 4, sequentially illustrating one embodiment of a method of fabricating a light emitting display.

Hereinafter, another method of fabricating the display portion 120 and the test pixel portion 126 will be described in conjunction with FIGS. 4, and 6A to 6C. The method of fabricating the display portion 120 will be described in reference only to a second transistor M2 and a display LED of a pixel circuit 125 of each display pixel 121. In some embodiments, the method of fabricating the first transistor M1 is the same as the method of fabricating the second transistor M2.

First, as shown in FIG. 6A, a buffer layer 210 is formed on substantially an entire surface of a substrate 110. Subsequently, a semiconductor layer 221 for a predetermined patterned transistor is formed on the buffer layer 210 in a display pixel region of the substrate 110. In one embodiment, the semiconductor layer 221 is formed of polycrystalline silicon and obtained by heat treatment of amorphous silicon. In certain embodiments, the amorphous silicon is crystallized to the polysilicon through a laser crystallization process comprising scanning a line beam using an excimer laser in a row direction.

After formation of the semiconductor layer 221, a gate insulating layer 230 is formed on the substrate 110 over the buffer layer 210 and the semiconductor layer 221. The gate insulating layer 230 may comprise an insulating material such as SiO₂, for example. After formation of the gate insulating layer 230, a gate electrode 241 is formed on the gate insulating layer 230 to overlap the semiconductor layer 221. The gate electrode 241 may comprise a conductive material such as Al, MoW, Al/Cu, for example. In one embodiment, a scan line S is formed of the same material as the gate electrode at the same time the gate electrode 241 is formed. Then, Ions are doped into a source region 221s and a drain region 221d of the semiconductor layer 221 of the substrate 110, thereby forming a channel 221c between the source region 221s and the drain region 221d.

After formation of the gate electrode 241, an interlayer insulating layer 250 is formed on the gate electrode 241. Subsequently, contact holes 265 and 267 are formed in the interlayer insulating layer 250 and the gate insulating layer 230 to expose the semiconductor layer 221.

After formation of the contact holes 265 and 267, a source electrode 261 and a drain electrode 263, comprising metal materials, are formed on the interlayer insulating layer 250 in a predetermined pattern. The source electrode 261 and the drain electrode 263 are electrically connected to the source region 221s and the drain region 221d through the contact holes 265 and 267, respectively. A data line D and a pixel power line VDD are also formed together with the source electrode 261 and the drain electrode 263.

Referring now to FIG. 6B, a passivation layer 270 is formed on the substrate 110, and a contact hole 272 is formed in the passivation layer 270 to expose the drain electrode 261. After formation of the contact hole 272, a lower electrode layer 280, implemented as the anode electrode of the display LED, is formed on the passivation layer. Thereby, the lower electrode layer 280 is electrically connected to the drain region 221d through the contact hole 272. Furthermore, test power lines 128 are formed on the passivation layer 270 in the test pixel region and spaced apart from each other by a predetermined interval. In one embodiment, the test power line 128 is simultaneously formed using the same mask as that used for formation of the lower electrode layer 280.

Referring now to FIG. 6C, a pixel defining layer 285 is formed on the lower electrode layer 280, the test power line 128, and the passivation layer 270. Following formation of the pixel defining layer 285, an opening dividing the pixel region is formed in the pixel defining layer 285, the display LED is formed in the opening formed in a region of the display portion 120, and simultaneously, the test LED is formed in the opening formed in the test pixel portion 126. In one embodiment, the test LED is simultaneously formed using the same mask as that used for formation of the display LED.

Finally, an upper electrode layer VSS, implemented as the cathode electrode of a light emitting diode 290 and the test LED, is formed on the light emitting diode 290 and the test LED. The upper electrode layer VSS is electrically connected to the second power line 152.

Referring back to FIG. 1, the light emitting display 100 supplies scan signals and data signals to the display portion 120 so as to enable the display LED of each display pixel 121 to emit light. Simultaneously with the supply of scan signals and data signals, the test power source Vtest is supplied to the test pixel portion 126 through the test power supply pad TPVdd, and the test LED emits light in response to the test power source Vtest. Thus, luminous properties of the test LED are evaluated by supplying the test power source Vtest, equal to the test signals supplied to the display portion 120, to the test power supply pad TPVdd so as to measure a current flowing through the test LED. Thereby, defects such as dark spots, bright spots, stains, and low brightness can be detected based on analysis of the emission of the test LED.

Accordingly, the light emitting display 100 can evaluate luminous properties of the display LED formed in the display portion 120 using luminous properties of the test LED. Specifically, the light emitting display 100 is configured to evaluate luminous properties of only the display LED, independent of the influence of the transistor in the display portion 120, using luminous properties of the test LED.

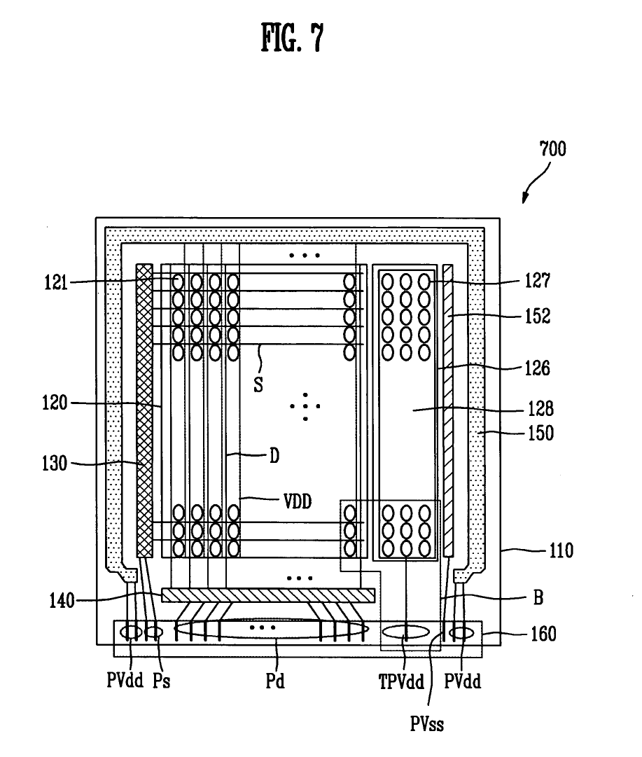

FIG. 7 is an illustration of another embodiment a light emitting display. Referring to FIG. 7, the light emitting display 700 comprises components similar to those of the light emitting display 100 of FIG. 1, except for the test pixel portion 126.

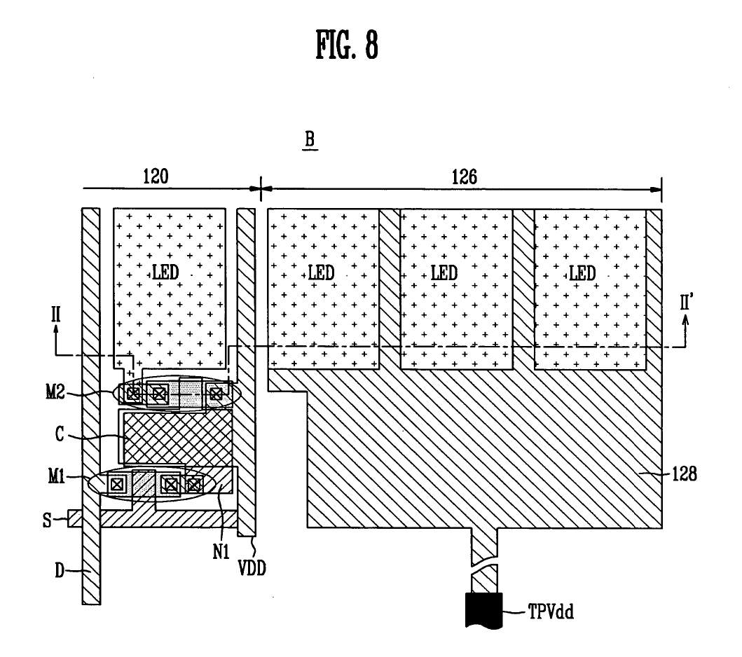

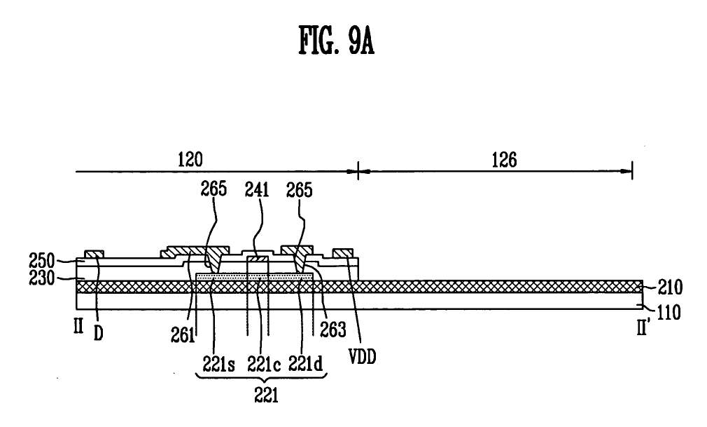

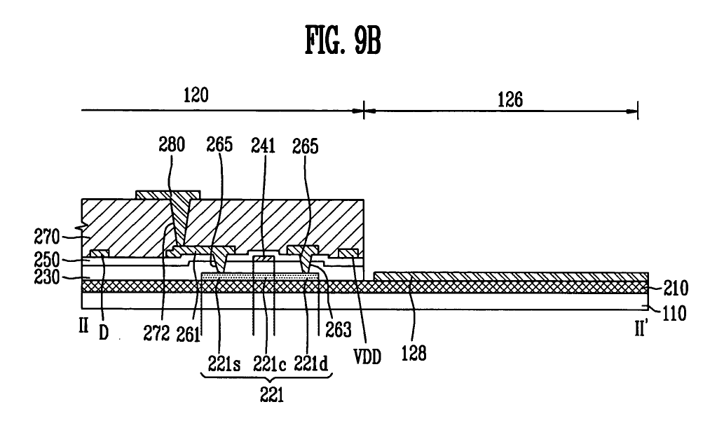

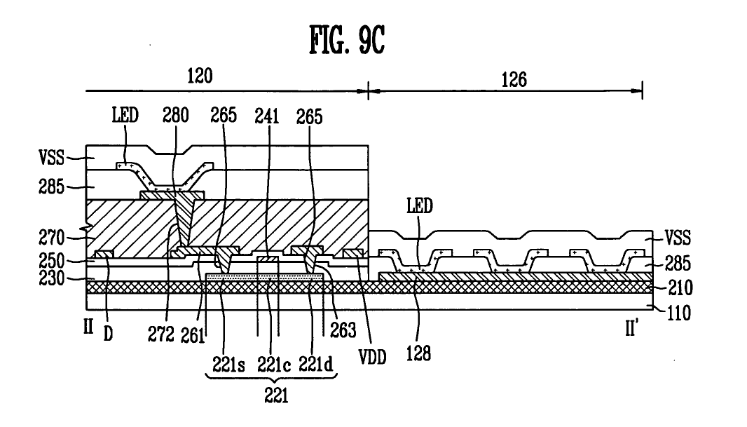

FIG. 8 is an enlarged view of the area B shown in FIG. 7, and FIGS. 9A to 9C are cross-sectional views taken along the line II-II′ shown in FIG. 8, sequentially illustrating one embodiment of a method of fabricating a light emitting display.

Referring to FIGS. 8, and 9A to 9C, another embodiment of a method of fabricating a display portion 120 and a test pixel portion 126 is similar to that illustrated in FIGS. 5A to 5C and described in reference thereto, except that the test power line 128 formed on the buffer layer 210 is formed in substantially an entire region of the test pixel portion 126. In one embodiment, the test power line 128 formed in an entire region of the test pixel portion 126 is simultaneously formed on a buffer layer 210 using the same mask as that used for forming the pixel power line VDD of the display portion 120. As a result, the test LEDs of the test pixel portion 126 emit light simultaneously during a test process rather than individually. Therefore, the light emitting display 700 has a reduced number of test power supply pads TPVdd formed on the substrate 110 as compared to the light emitting display 100.

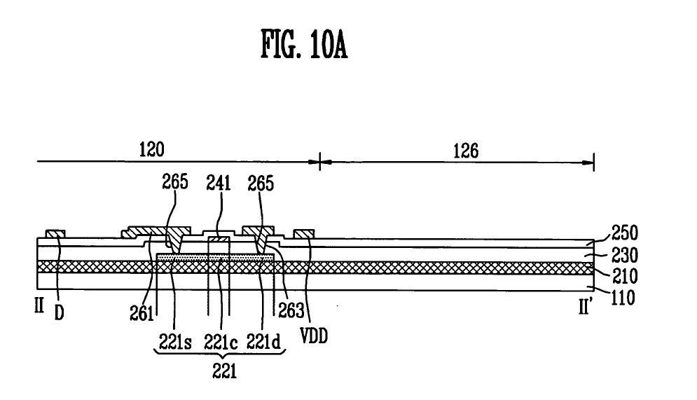

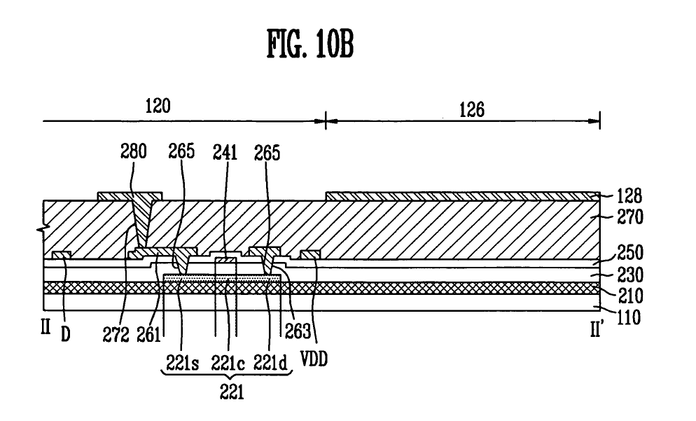

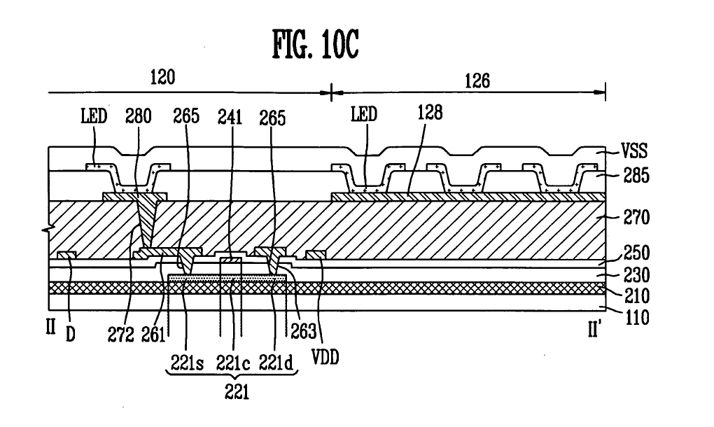

FIGS 10A to 10C are cross-sectional views taken along the line II-II′ shown in FIG. 8, sequentially illustrating another embodiment of a method of fabricating the light emitting display 700. Referring to FIGS. 8, and 10A to 10C, the illustrated method of fabricating the display portion 120 and the test pixel portion 126 is similar to that illustrated in FIGS. 6A to 6C and described in reference thereto, except that a test power line 128 formed on the passivation layer 270 is formed in substantially an entire region of the test pixel portion 126.

In one embodiment, the test power line 128 is simultaneously formed using the same mask as that used for forming a lower electrode layer 280 formed in the display portion 120. As a result, the test LEDs of the test pixel portion 126 emit light simultaneously during a test process rather than individually

In operation, the light emitting display 700 emits light from the display LED of each display pixel 121 by supplying scan signals and data signals to the display portion 120. Simultaneously with the supply of scan signals and data signals, the test power source Vtest is supplied to the test pixel portion 126 independent from the display portion 120 through the test power supply pads TPVdd, thereby emitting light from the test LED. Thus, luminous properties of the test LED are evaluated by supplying the test power source Vtest, equal to the test signals supplied to the display portion 120, to the test power supply pads TPVdd and measuring a current flowing through the test LED. Accordingly, defects such as dark spots, bright spots, stains, and low brightness can be evaluated based on the emission of the test LED.

Thus, the light emitting display 700 can evaluate luminous properties of the display LED formed in the display portion 120 using luminous properties of the test LED. Specifically, the light emitting display 700 can evaluate luminous properties of the display LED independent of influence by the transistor in the display portion 120 using luminous properties of the test LED.

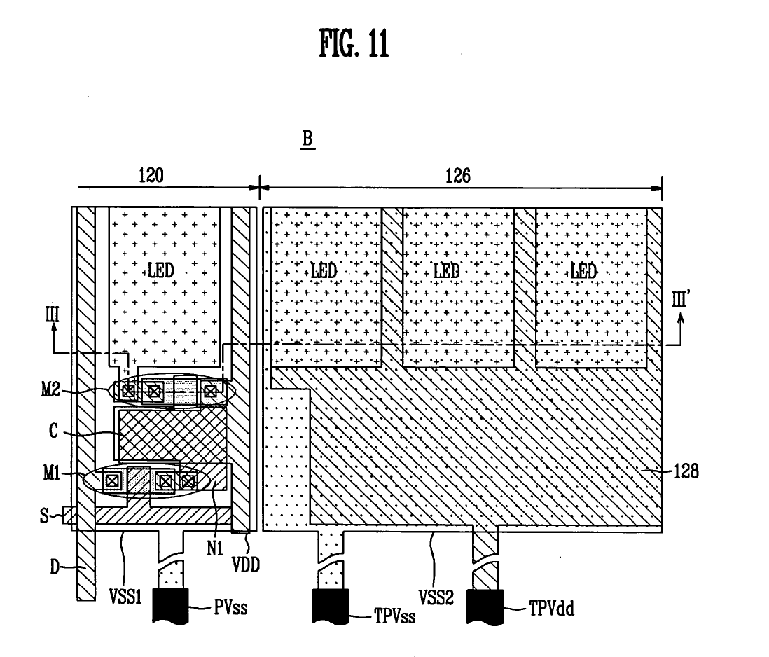

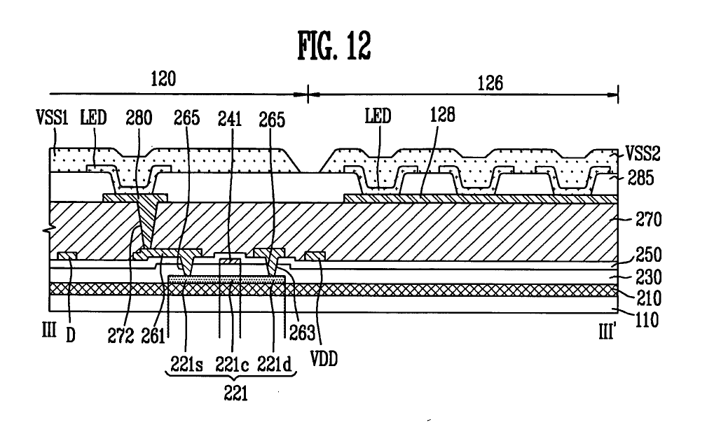

FIG. 11 is an enlarged view illustrating an alternative layout of the area B shown in FIG. 8, and FIG. 12 is a cross-sectional view taken along line III-III′ of FIG. 11. Referring to FIGS. 11 and 12, the light emitting display in accordance with yet another embodiment of the invention has components similar to other embodiments, except that a second power source VSS is separately formed between the display portion 120 and the test pixel portion 126.

The second power source VSS has a second display power source VSS1 and a second test power source VSS2. A second display power supply pad PVss, electrically connected to the second display power source VSS1, and a second test power supply pad TPVss, electrically connected to the second test power source VSS2, are formed on the substrate 110.

Specifically, the second display power source VSS1 is formed in only the display pixel region of the substrate 110 corresponding to the display portion 120. The second display power source VSS1 is electrically connected to a cathode electrode of the display LED composing each pixel 121 of the display portion 120. Therefore, the second display power source VSS supplies a second display voltage the display LED from the second display power supply pad PVss. In addition, the second test power source VSS2 is formed in only the test pixel region of the substrate 110 corresponding to the test pixel portion 126. The second test power source VSS2 is electrically connected to the cathode electrode of the test LED of the test pixel portion 126. As a result, the second test power source VSS2 supplies the second test voltage to the test LED from the second test power supply pad TPVss

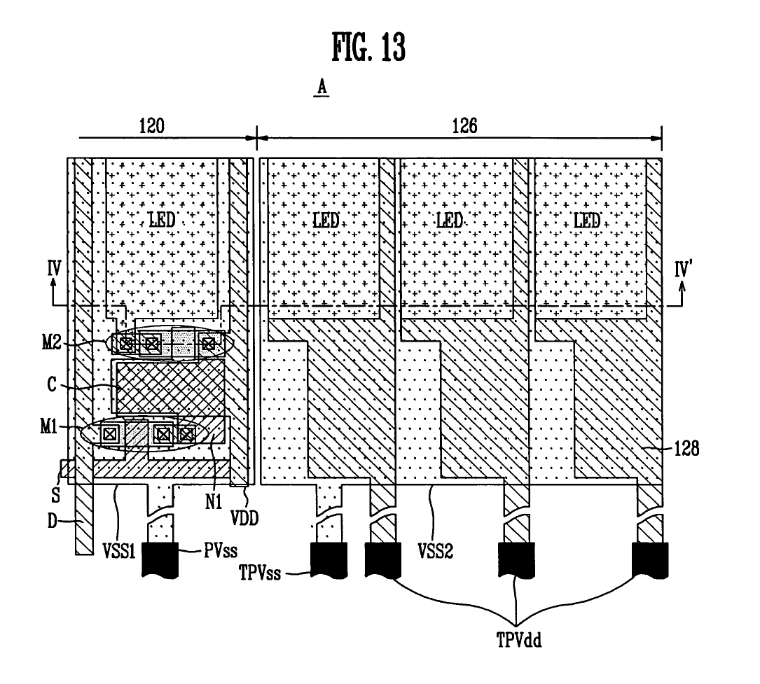

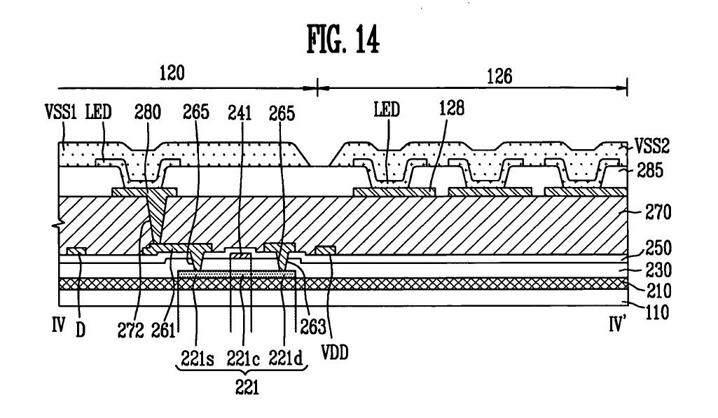

FIG. 13 is an enlarged view illustrating an alternative layout of the area A of FIG. 1, and FIG. 14 is a cross-sectional view taken along line IV-IV′ of FIG. 13.

Referring to FIGS. 13 and 14, another embodiment of a light emitting display includes components similar to those of other embodiments, except for a second power source VSS and a test power line 128.

The second power source VSS comprises a second display power source VSS1 and a second test power source VSS2. A second display power supply pad PVss, electrically connected to the second display power source VSS1, and a second test power supply pad TPVss, electrically connected to the second test power source VSS2, are formed on the substrate 110.

In one embodiment, the second display power source VSS1 is formed in only the display pixel region of the substrate 110 corresponding to the display portion 120. The second display power source VSS1 is electrically connected to a cathode electrode of the display LED composing each pixel 121 of the display portion 120. Thereby, the second display power source VSS1 supplies a second display voltage to the display LED from the second display power supply pad PVss. In addition, the second test power source VSS2 is formed in only the test pixel region of the substrate 110 corresponding to the test pixel portion 126. The second test power source VSS2 is electrically connected to the cathode electrode of the test LED. Thus, the second test power source VSS2 supplies the second test voltage to the cathode electrode of the test LED from the second test power supply pad TPVss.

Still in reference to FIGS. 13 and 14, a plurality of test power lines 128 are formed on a passivation layer 270, wherein the test power lines 128 are formed in the test pixel region to be spaced apart from each other by a predetermined interval. In one embodiment, the plurality of test power lines 128 are independently formed in a region of the test pixel portion 126. In certain embodiments, the test power lines 128 are simultaneously formed using the same mask as that used for forming the lower electrode layer 280. The plurality of test power lines 128 are electrically connected to an anode electrode of the test LED. Thereby, each test power line 128 supplies the test power source from the test power supply pad TPVdd to the anode electrode of the test LED.

As can be seen from the foregoing, embodiments of a light emitting display are capable of evaluating the properties of a light emitting diode using a test pixel portion formed in a dummy region of a substrate. In certain embodiments, a method of fabricating the light emitting display comprises simultaneously forming a display portion having active driving type pixels and a test pixel portion in the same substrate, wherein the active driving type pixels comprise a transistor and the test pixel portion comprises passive driving type pixels. Accordingly, embodiments of the invention are capable of evaluating the properties of the light emitting diode, independent of the influence of the transistor, in the light emitting display having a pixel circuit including the transistor.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A light emitting display, comprising:
a display portion formed on a substrate and comprising a first pixel, wherein the first pixel is configured to emit light based on a current supplied from an active driving pixel circuit having at least one transistor; and
a test portion formed on the substrate and having a second pixel, wherein the second pixel is configured to emit light based on a current supplied by a passive driving method.

2. The light emitting display according to claim 1, wherein the first pixel comprises a light emitting diode configured to emit light based on a current supplied from a first power line, wherein the pixel circuit is electrically connected to a scan line, a data line, and the first power line.

3. The light emitting display according to claim 1, wherein the second pixel comprises a dummy light emitting diode electrically connected to a dummy power line and a second power line.

4. The light emitting display according to claim 1, wherein the second display portion is configured for testing the light emitting display.

5. The light emitting display according to claim 3, wherein the dummy power line is commonly formed in the second display portion.

6. The light emitting display according to claim 3, wherein a plurality of dummy power lines are formed in the second display portion and spaced apart from each other by a predetermined interval.

7. The light emitting display according to claim 3, wherein the second power line is commonly formed in the first and second display portions.

8. The light emitting display according to claim 3, wherein the second power line is formed independently in the first and second display portions.

9. The light emitting display according to claim 2, wherein the pixel circuit comprises:
a first transistor controlled by scan signals supplied to the scan line and configured to output data signals received on the data line;
a second transistor configured to supply a current to the light emitting diode from the first power line, wherein the current corresponds to a voltage supplied to a gate electrode of the second transistor from the first transistor; and
a capacitor configured to store a voltage corresponding to the data signal and drive the second transistor based on the stored voltage.

10. A light emitting display, comprising:
a display portion formed on a substrate and comprising a pixel configured to emit light based on a current, wherein the current is supplied from a first power line by a pixel circuit having at least one transistor; and
a test portion formed in a dummy region on the substrate and comprising a dummy pixel configured to emit light based on a current supplied from a dummy power line.

11. The light emitting display according to claim 10, wherein the pixel comprises a light emitting diode configured to emit light based on the current supplied from the first power line by the pixel circuit, wherein the pixel circuit is electrically connected to a scan line, a data line, and the first power line.

12. The light emitting display according to claim 10, wherein the dummy pixel comprises a dummy light emitting diode electrically connected to the dummy power line and a second power line.

13. The light emitting display according to claim 10, wherein the pixel circuit comprises:
a first transistor controlled by scan signals supplied to the scan line, wherein the first transistor is configured to output data signals from the data line;
a second transistor configured to supply a current to the light emitting diode from the first power line, wherein the current corresponds to a voltage supplied from the first transistor to a gate electrode of the second transistor; and
a capacitor configured to store a voltage corresponding to the data signals and to drive the second transistor based on the stored voltage.

14. A light emitting display, comprising:
a display portion formed in an emission region of a substrate and configured to display images; and
a test portion formed in a dummy region of the emission region with the display portion.

15. The light emitting display according to claim 14, wherein the display portion comprises:
a pixel circuit electrically connected to a scan line, a data line, and a first power line, each formed in the substrate; and
a pixel comprising a light emitting diode configured to emit light by receiving a current from the first power line via the pixel circuit, wherein the received current corresponds to data signals supplied to the data line.

16. The light emitting display according to claim 14, wherein the test portion comprises a dummy pixel comprising a dummy light emitting diode electrically connected to a dummy power line and a second power line, each formed on the substrate.

17. A method of fabricating a light emitting display, comprising:
forming a pixel circuit defined by a plurality of scan lines, a plurality of data lines, and a power line on an emission region of a substrate, wherein the pixel circuit comprises at least one transistor configured to output a current from the power line corresponding to data signals of the data line;
forming a dummy power line in an anode electrode connected to the pixel circuit, and a dummy region of the emission region;
forming a light emitting diode for connection to the pixel circuit and forming a dummy light emitting diode for connection to the dummy power line; and
forming a cathode electrode on the light emitting diode and the dummy light emitting diode.

18. The method according to claim 17, further comprising forming an insulating layer configured to separate the light emitting diode and the dummy light emitting diode from each other.

19. The method according to claim 17, wherein the light emitting diode and the dummy light emitting diode are formed in openings exposed by the insulating layer.

20. The method according to claim 17, wherein forming the dummy power line comprises forming a continuous dummy power line in the dummy region.

21. The method according to claim 17, wherein forming the dummy power line comprises forming a plurality of dummy power lines in the dummy region, and wherein the dummy power lines are spaced apart from each other by a predetermined interval.

22. The method according to claim 17, wherein forming the pixel circuit comprises:
forming a buffer layer on the substrate;
forming at least one transistor and capacitor on the buffer layer; and
forming a passivation layer covering the transistor.

23. The method according to claim 22, wherein the dummy power line is formed on one of the buffer layer and the passivation layer.

24. The method according to claim 17, wherein the cathode electrode is continuously formed in the emission region and the dummy region.

25. The method according to claim 17, wherein the cathode electrode is separately formed in the emission region and the dummy region.
